(19) United States
(12) Patent Application Publication
(10) Pub. No.: US 2008/0052874 A1
(43) Pub. Date: Mar. 6, 2008

(54) Flat hinge assembly

(75) Inventor: Te-Yang Liu, Shulin City (TW)

Correspondence Address: BIRCH STEWART KOLASCH & BIRCH, PO BOX 747, FALLS CHURCH, VA, 22040-0747, US

(73) Assignee: SHIN ZU SHING CO., LTD.

(21) Appl. No.: 11/504,695

(22) Filed: Aug. 16, 2006

(51) Int. Cl. E05D 7/04

(52) U.S. Cl. 16/246

(57) ABSTRACT

A flat hinge assembly has a base and a body. The base is mounted securely on a keyboard of a plane electronic device and has at least one protrusion. The body is mounted pivotally on the base and has a pivoting leaf and an extending leaf. The pivoting leaf has a proximal end mounted pivotally on the base. The extending leaf is mounted securely on a monitor of the plane electronic device, is mounted slidably on the pivoting leaf and has at least one slot selectively engages with the protrusion of the base. With such an arrangement, the monitor of the plane electronic device can be push to coincide with the keyboard, so that the plane electronic device may have a smallest volume for carrying conveniently. Furthermore, the monitor can be pivoted to an appropriate angle to avoid reflecting light and facilitate users to watch.

### BACKGROUND OF THE INVENTION

1. Field of the Invention

The present invention relates to a hinge, and more particularly to a flat hinge assembly that makes the plane electronic devices smaller and convenient to use.

2. Description of Related Art

A plane electronic device such as a calculator, a plane cellular phone or a plane notebook mainly comprises a bracket, a keyboard and a monitor. The keyboard and the monitor are mounted in an operational surface of the bracket adjacent to each other, such that users of the plane electronic device can key in data and watch the monitor at the same time.

However, said conventional plane electronic devices are mostly very large because of the sizes of the monitors and the keyboards, and consequentially, carrying the plane electronic devices is inconvenient. Moreover, the monitor of a plane electronic device normally cannot be pivoted to lift from the operational surface. Such if the monitor reflects light, user have to turn the whole plane electronic device to adjust the position of the monitor so as to watch the monitor clearly. With above mentions, it is known that the conventional plane electronic devices are not only inconvenient to carry but also inconvenient to use.

To overcome the shortcomings, the present invention provides a flat hinge assembly to obviate or mitigate the aforementioned problems.

### SUMMARY OF THE INVENTION

The objective of the present invention is provide a flat hinge assembly that makes a plane electronic devices to have a smallest volume for carrying conveniently, and furthermore, allows a monitor of the plane electronic device to pivot to facilitate watching.

To achieve the main objective, the flat hinge assembly comprises a base and a body.

The base is adapted to mount securely within a keyboard of a plane electronic device and has a proximal end, a distal end, two sides and at least one protrusion. The at least one protrusion protrudes on the distal end from one of the sides of the base.

The body is pivotally mounted on the base and has a pivoting leaf and an extending leaf. The pivoting leaf has a proximal end mounted pivotally with the proximal end of the base. The extending leaf is adapted to mount securely with a monitor of the plane electronic device, which is slidably mounted with the pivoting leaf and has at least one slot selectively engages with the protrusion of the base.

With such an arrangement, the plane electronic device mounted with the flat hinge assembly in accordance with the present invention is able to have a smallest volume to carry conveniently. Moreover, the monitor of the plane electronic device can be pivoted to lift from the keyboard to avoid the monitor reflecting light and facilitate users to watch.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a flat hinge assembly in accordance with the present invention;

FIG. 2 is an exploded perspective view of the flat hinge assembly in FIG. 1;

FIG. 3 is an another exploded perspective view of the flat hinge assembly in FIG. 1;

FIG. 4 is a bottom view of the flat hinge assembly in FIG. 1;

FIG. 5 is an operational bottom view of the flat hinge assembly in FIG. 1;

FIG. 6 is an operational perspective view of the flat hinge assembly in FIG. 1;

FIG. 7 is an another operational perspective view of the flat hinge assembly in FIG. 1;

FIG. 8 is a side view of a plane electronic device mounted with the flat hinge assembly in FIG. 1; and

FIG. 9 is an operational side view of the plane electronic device mounted with the flat hinge assembly in FIG. 1.

### DETAILED DESCRIPTION OF THE PREFERRED EMBODIMENT

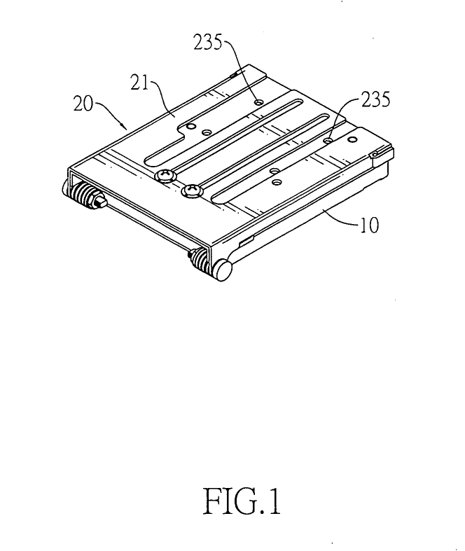

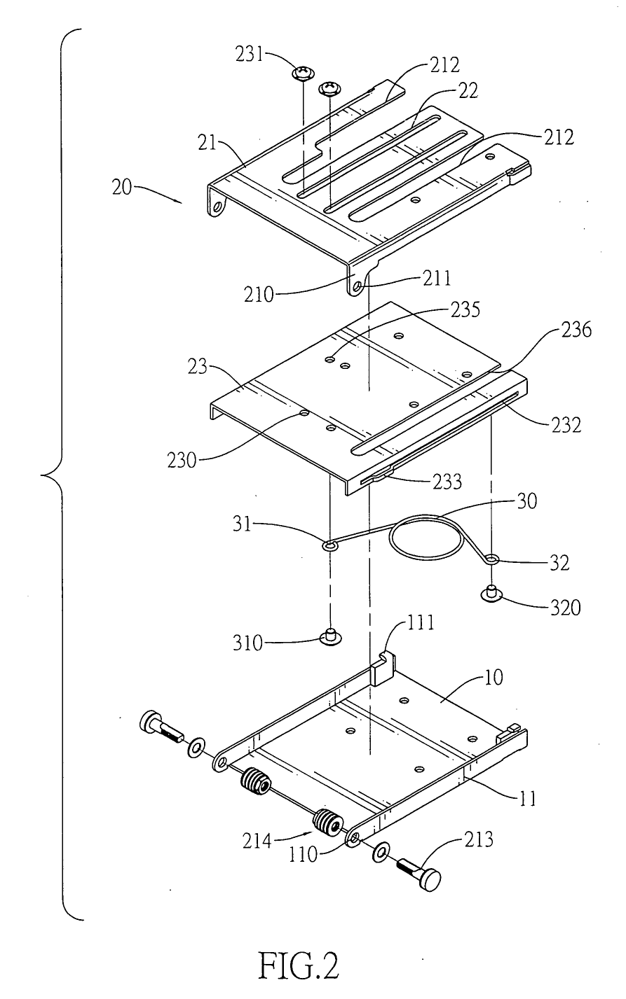

With reference to FIGS. 1 and 2, the flat hinge assembly in accordance with the present invention comprises a base (10) and a body (20).

The base (10) has a proximal end, a distal end and two sidewalls (11). Each sidewall (11) has a protrusion (111) and a through hole (110). The protrusion (111) is protruding from the sidewall (11) near the distal end of the base (10). The through hole (110) is defined through the sidewall (11) near the proximal end of the base (10). The through holes (110) in the sidewalls (11) align with each other.

The body (20) is mounted pivotally on the base (10) and has a pivoting leaf (21) and an extending leaf (23).

The pivoting leaf (21) is mounted pivotally on the base (10) and has a proximal end, a bottom surface, two mounting taps (210), two sliding grooves (22), two cutouts (212) and may have two bushing assemblies. The mounting taps (210) are oppositely formed perpendicularly on the bottom surface near the proximal end of the pivoting leaf (21), each mounting tap (210) has a mounting hole (211) formed through the mounting tap (210) and corresponding with one of the through holes (110) of the base (10). The sliding grooves (22) are defined longitudinally through the pivoting leaf (21) parallel to each other, and each sliding groove (22) has a determined length. The cutouts (212) are defined separately through the pivoting leaf (21). Each one of the bushing assemblies comprises a nut, a pintle (213), and multiple bushing elements (214). The pintles (213) of the bushing assemblies are mounted respectively through the mounting holes (211) of the mounting taps (210) and the through holes (110) of the base (10). The nuts respectively screw onto the pintles (213) to mount the pivoting leaf (21) pivotally on the base (10). The bushing elements (214) are mounted respectively around the pintles (213) and rub against the pivoting leaf (21) to hold the pivoting leaf (21) in position when the pivoting leaf (21) is pivoted.

The extending leaf (23) is mounted slidably on the pivoting leaf (21) and has an opening (236), two fastening holes (230), two fastening elements (231), two walls, two slots (232), multiple connecting holes (235) and may have a resilient element (30).

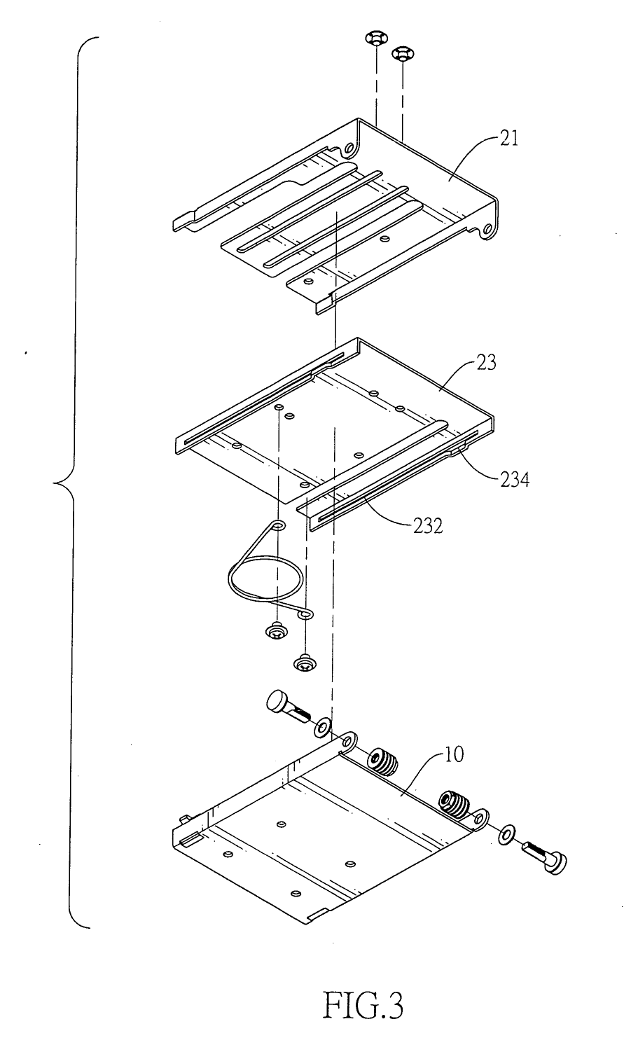

With further reference to FIG. 3, the opening (236) is defined longitudinally through the extending leaf (23). The fastening holes (230) are formed separately through the extending leaf (23) and correspond respectively to the sliding grooves (22) of the pivoting leaf (21). The fastening elements (231) are mounted respectively through the sliding grooves (22) and are respectively mounted securely in the fastening holes (230) and received slidably in the sliding grooves (22) so as to allow the extending leaf (23) slides relative to the pivoting leaf (21). The walls are formed oppositely on the extending leaf (23), correspond to and are wider than the sidewalls (11) of the base (10). The slots (232) are respectively formed longitudinally through the walls of the extending leaf (23) and selectively engage with the protrusions (111). Each slot (232) has a proximal end and a receiver (233). The receiver (233) is formed near the proximal end of the slot (232), protrudes from the wall of the extending leaf (23) and forms a gap (234). The gaps (234) of the receivers (233) communicate with the slots (232) and selectively engage the protrusions (111) of the base (10). The connecting holes (235) are formed through the extending leaf (23) and correspond respectively to the cutouts (212) of the pivoting leaf (21).

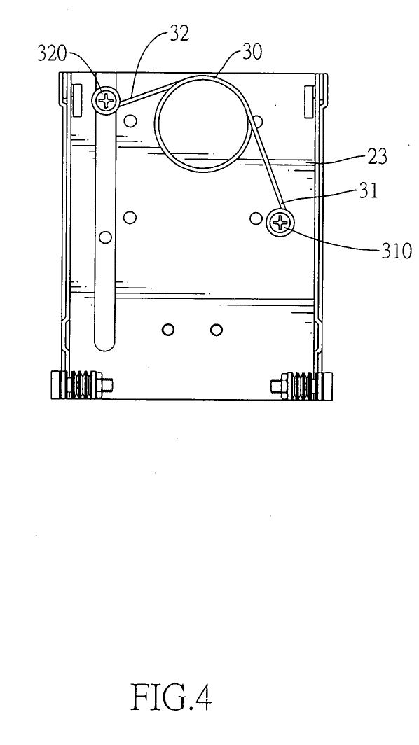

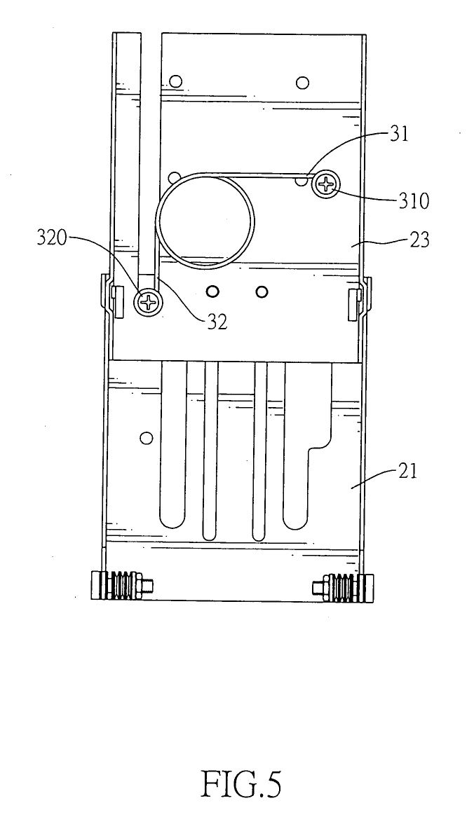

With further reference to FIGS. 4 and 5, the resilient element (30) is mounted in the extending leaf (23) and has a first end (31) and a second end (32). The first end (31) is fastened on the bottom surface of the extending leaf (23) by a fastener (310). The second end (32) is fastened on the pivoting leaf (21) by a fastener (320) extending through the opening (236) of the extending leaf (23) and selectively pushes the extending leaf (23) to maintain an extending status.

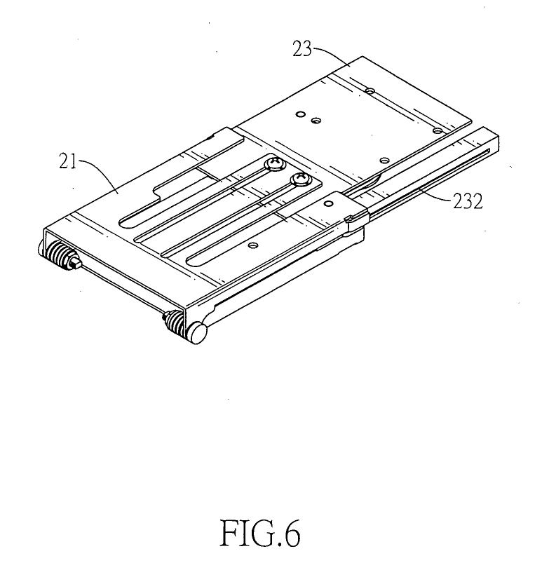

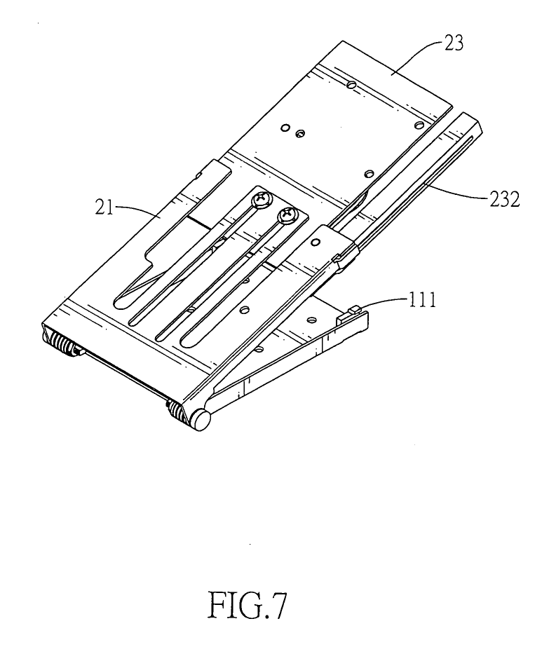

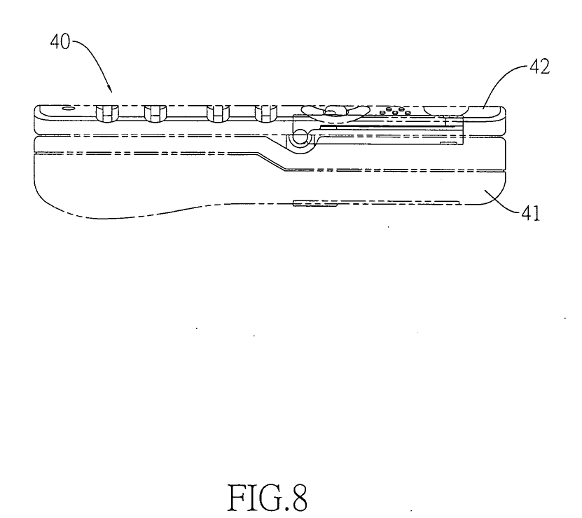

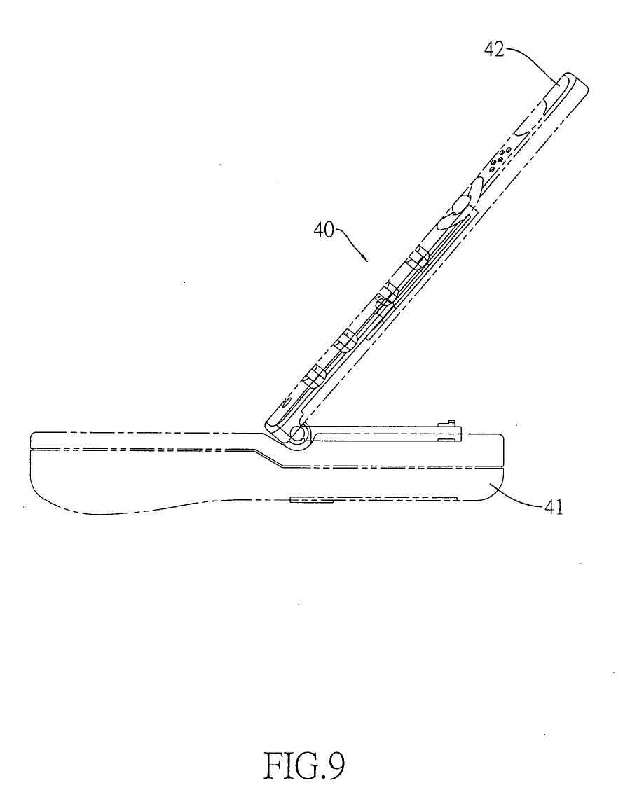

With further reference to FIGS. 6, 7, 8 and 9, a plane electronic device (40) includes a monitor (42) and a keyboard (41), wherein the monitor (42) is attached to the extending leaf (23) and the keyboard (41) is mounted securely on the base (10). Such, by the extending leaf (23) slides relative to the pivoting leaf (21), the monitor (42) can move relative to the keyboard (41). When the monitor (42) covers the keyboard (41), the plane electronic device (40) has a smallest volume for carry. The user also can slide the monitor (42) to reveal the keyboard (41) to facilitate users to use.

When the monitor (42) moves to reveal the keyboard (41), the protrusions (111) of the base (10) will correspond to the gaps (234) and may disengage from the slots (232), such that the monitor (42) can be pivoted to an appropriate angle to avoid reflecting light and facilitate users to watch via the pivoting leaf (21) pivots relative to the base (10).

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A flat hinge assembly comprising
a base having
a proximal end;
a distal end; and
two sidewalls, and each sidewall having a protrusion protruding from the sidewall near the distal end of the base; and
a body mounted pivotally on the base and including
a pivoting leaf having a proximal end being mounted pivotally with the proximal end of the base;
an extending leaf being mounted slidably with the pivoting leaf to extend from the pivoting leaf and having
two walls being formed oppositely on the extending leaf, corresponding to and being wider than the sidewalls of the base;
two slots being respectively formed longitudinally through the walls of the extending leaf and selectively engaging with the protrusions, each slot having
a proximal end; and
a receiver being formed near the proximal end of the slot, protruding from the wall and forming a gap communicating with the slots and being selectively engaged one of the protrusions of the base.

2. The flat hinge assembly as claimed in claim 1 further comprising a resilient element being mounted in the extending leaf and having
a first end fastened on the extending leaf; and
a second end fastened on the pivoting leaf and selectively pushing the extending leaf.

3. The flat hinge assembly as claimed in claim 2, wherein
the base further has two through holes being defined respectively through the sidewalls near the proximal end of the base and aligning with each other; and
the pivoting leaf further has two mounting taps being oppositely formed perpendicularly in the proximal end of the pivoting leaf, each mounting tap having a mounting hole corresponding to one of the through holes of the base.

4. The flat hinge assembly as claimed in claim 3, wherein the extending leaf further comprises two bushing assemblies, each comprising
a nut;
a pintle being mounted through one of the mounting hole of the mounting taps and one of the through holes of the base and mounted securely with the nut; and
multiple bushing elements being mounted around the pintle and rubbing against the pivoting leaf.

5. The flat hinge assembly as claimed in claim 2, wherein
the pivoting leaf further has two sliding grooves being defined longitudinally through the pivoting leaf parallel to each other; and
the extending leaf further has
two fastening holes being formed separately through the extending leaf, corresponding respectively to the sliding grooves of the pivoting leaf; and
two fastening elements being mounted through the sliding grooves respectively and respectively mounted securely in the fastening holes and received slidably in the sliding grooves.

6. The flat hinge assembly as claimed in claim 2, wherein
the pivoting leaf further has two cutouts being separately defined through the pivoting leaf, and
the extending leaf further has multiple connecting holes corresponding respectively to the cutouts of the pivoting leaf.
